(19) United States
(12) Patent Application Publication
(10) Pub. No.: US 2020/0099786 A1
(43) Pub. Date: Mar. 26, 2020

(54) CALL CENTER TASK SETUP SYSTEM AND METHOD

(71) Applicant: MILLER FORD TECHNOLOGY PTE LTD, Singapore (SG)

(72) Inventor: HUI-LONG LIN, Kaohsiung City (TW)

(21) Appl. No.: 16/142,600

(22) Filed: Sep. 26, 2018

(51) Int. Cl. H04M 3/51; G06Q 30/02; G06F 17/30; H04M 3/533

(52) U.S. Cl. CPC H04M 3/5158; G06Q 30/0203; H04M 3/5175; H04M 3/53375; G06F 17/30864

(57) ABSTRACT

The disclosure is related to a call center task setup system and method. A server system having a database and executing a web server is provided, such that a connected user device can set up a call center task via web pages. A task setup page is provided to set up an automatic dialing function, calling time, the number of calls, and recipient conditions. A questionnaire setup page is provided to create one or more questions and set up a questionnaire procedure. A voice-recording setup page is provided to set up a voice file for each question. A recipient phone number setup page is provided to set up a recipient list according to the recipient conditions. Therefore, the call center task setup system can make phone calls to the recipients with the automatic dialing function and execute the questionnaire procedure.

### FIELD OF THE DISCLOSURE

The specification discloses a technology for a customer to set up a call center task; in particular, to a method for a customer to set up a call center task by using a webpage user interface and a relevant computer system.

### BACKGROUND OF THE DISCLOSURE

When needing to conduct a market research or when marketing products, an organization often uses a call center to make extensive telephone interviews to specific customers. In a conventional manner, research content or a product introduction is provided for a call center agent. Then, the call center agent conducts the traditional market research or marketing process by using telephone numbers obtained after sampling from a phone book, and creates a report according to a market research result or marketing result.

In addition, a computer system in the call center may automatically select phone numbers and make phone calls. After the call is put through, the call center agent conducts a market research based on research content or reads a product introduction to perform telephone marketing, and afterwards, needs to record a post-call report.

In addition, by means of digital voice files recorded in advance or technology using automatic pinyin to generate machine speech, a first-order, second-order, and third-order speech question are produced after a menu is designed. The computer system in the call center automatically selects numbers and makes phone calls, and reads digital speech after the call is put through to fulfill the task of market research or advertising & marketing.

In the related art, before using the call center to conduct marketing, market research or questionnaires, the organization needs to first contact the sales department of the call center to discuss the contents to be used in the marketing, market research or questionnaires in order to design questions therefor. An automated customer service has yet to be provided in the relevant industry.

### SUMMARY OF THE DISCLOSURE

The disclosure discloses a call center task setup system and method. A server system is provided, where a web server is executed to enable a customer to set up a call center task at any time via webpages, that is, to set up an automatic dialing function for a telephone interview via webpages, such that a call center agent can conduct the telephone interview according to the call center task.

In an embodiment, a call center task setup system is provided with a server system having a database, and a call center task is set up via webpages to perform a call center task setup method, where the method includes: providing a task setup page to set up an automatic dialing function, calling time, the number of calls, and recipient conditions; providing a questionnaire setup page to create one or more questions and set up a questionnaire procedure; providing a voice-recording setup page, such that a customer can set up at least one voice file for every question, for example, the customer can upload via the network a voice file recorded for every question; and providing a recipient phone number setup page via which a recipient list can be set up according to the recipient conditions, and a phone number generation manner can be accordingly selected.

When the call center task is started, the call center task setup system makes phone calls to recipients with the automatic dialing function based on the calling time, the number of calls, and the recipient list that are set via the webpages by the customer, and executes the questionnaire procedure.

Further, after the customer completes setup of the call center task by using the call center task setup system, the system automatically calculates a cost according to various demands.

Further, the system provides a task query page to query for statuses of the recipients, and estimate whether to perform a switch to a new task; and the system also provides a report query page to query for an interview result with respect to the call center task.

Further, the voice file is recorded with a user device connected to the call center task setup system, and is then uploaded to the call center task setup system via the voice-recording setup page.

In order to further understand techniques, methods, and effects used to achieve the intended purposes of the present invention, reference is made to the following detailed descriptions and drawings related to the present invention. Therefore, the objectives, features, and characteristics of the present invention can be deeply and specifically understood. However, the accompanying drawings are merely used for provision of reference and explanation, but not intended to limit the present invention.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic diagram of an embodiment showing a system architecture of a call center task setup system;

FIG. 2 is a flowchart of an embodiment of a call center task setup method;

FIG. 3 is a flowchart of an embodiment showing task execution in the call center task setup method;

FIG. 4 is a schematic diagram of an embodiment showing task setup using a user interface;

FIG. 5 is a schematic diagram of an embodiment showing questionnaire setup using a user interface;

FIG. 6 is a schematic diagram of an embodiment showing voice recording setup using a user interface;

FIG. 7 is a schematic diagram of an embodiment showing setup of recipient phone numbers using a user interface;

FIG. 8 is a schematic diagram of an embodiment showing a task query using a user interface;

FIG. 9 is a schematic diagram of an embodiment showing a report query using a user interface; and

FIG. 10 shows an implementation instance in which a report is produced by using the call center task setup system.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

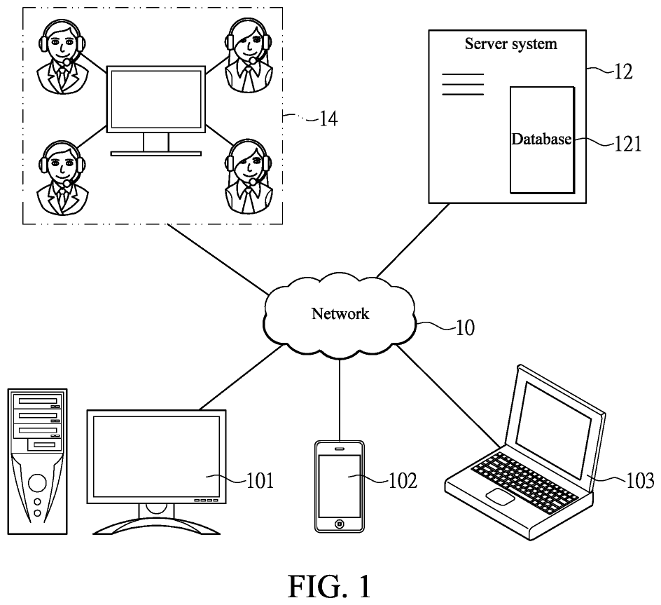

The disclosure provides a call center task setup system and method, which enable a customer to remotely set up a call center task via the network and webpages. A relevant system architecture is shown in FIG. 1, which is a schematic diagram of an embodiment showing a system architecture of the call center task setup system.

In FIG. 1, a server system 12 having a database is provided. Based on different data categories, the database may include a customer service database for a customer to design questionnaire content, a recipient database for setting information about a variety of recipients according to recipient conditions, and a task database for storing call center tasks.

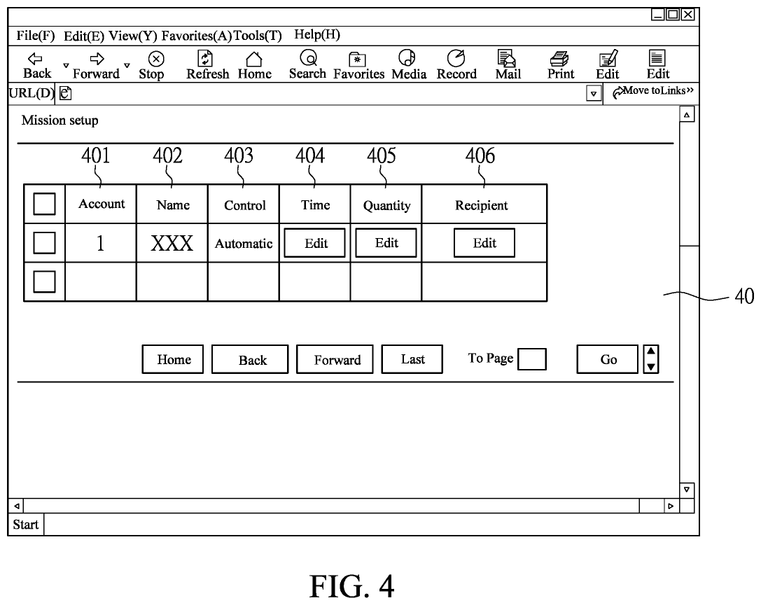

User device 101, 102, and 103 can access data in the server system 12 via the network 10, and set up a call center task via webpages. The webpages mentioned herein may generally refer to various user interfaces enabled by software programs, and resources in the server system 12 can be accessed via these user interfaces. According to an embodiment of the call center task setup system, the server system 12 executes a web server, such that the user device 101, 102, and 103 can set up a call center task via the webpages enabled by the web server. Embodiments shown in FIG. 4 to FIG. 9 describe that various pages are used to set up call center tasks that the call center 14 is required to execute. For example, the web server provides a task setup page via which the customer can set the calling time, number of calls, and recipient conditions by using different columns and options. Thus, an automatic dialing function can be executed, such that the software program in the server system 12 automatically executes a dialing action to make a phone call according to parameters such as the calling time, number of calls, and recipient conditions. After the call is put through, agents in the call center 14 can make an interview according to a questionnaire.

It should be noted that, the telephone may generally refer to a variety of audio contact manners, including conventional voice calls made via the public switched telephone network (PSTN) and network communication manners using a voice packet to deliver voice. All these manners are feasible.

In addition to the manner in which the call center agents execute the questionnaire procedure, by combination of the call center 14 and the server system 12 in main embodiments of the call center task setup system, pre-recorded voice files may be played back in order according to the questionnaire procedure after the system dials in, so that no call center agent is required, and an interview result is recorded.

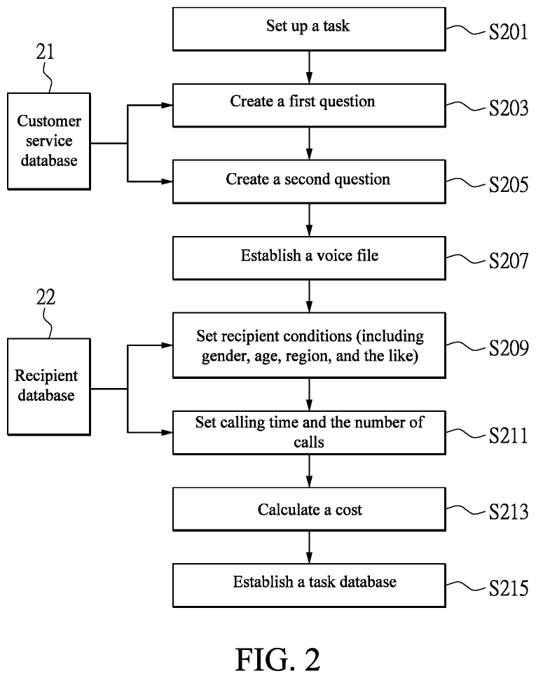

FIG. 2 is a flowchart of an embodiment of a call center task setup method.

At the beginning of the process, as described in step S201, a customer connects a user device to a server system, and sets up a call center task via webpages enabled by a web server executed in the server system. Specifically, one or more questions are created. In step S203 in this embodiment, a first question is created via a questionnaire setup page by using the customer service database 21 of the system; specifically, the first question may be created via menus and columns provided by the customer service database 21. Then, as described in step S205, a second question may be subsequently created in an order on the questionnaire and according to logic between the questions, to form a questionnaire procedure.

Afterwards, in step S207, for each question, the customer may establish a voice file via a voice-recording setup page. For example, both at least one voice file recorded via the webpage for each question and a pre-recorded voice file are uploaded to the server system via the webpage.

Then, in step S209, recipient conditions may be set via a task setup page according to the questionnaire design, where information such as gender, age, region, and occupation may be provided by the recipient database 22 of the system. Specifically, a recipient phone number setup page provided by the system may be used to set up a recipient list according to the recipient conditions. For example, if the questionnaire is related to issues about working women, female respondents in a particular age group and job category may be set as the recipients; or if the questionnaire is related to issues about residents in a particular region, people of either sex who live in this region may be selected as the recipients.

Subsequently, in step S211, the calling time and number of calls are set via a task setup page, where the set time and number may be stored in the recipient database 22. The calling time may be set to a time at which a phone interview is made, such as morning, noon, afternoon, or evening. The recipients may be selected from a particular group due to the different time periods. With respect to the number of calls, the customer sets a maximum number, and the questionnaire procedure may be stopped when the maximum number is reached. Moreover, the system may charge the customer according to the set calling time and number. As described in step S213, the system may calculate a cost based on parameters such as the number of questions, the number of recipients, the number of dialing actions, and time.

Finally, in step S215, the server system obtains various parameters of the call center task via different webpages, and establishes a task database, where the calling time is set in the task database.

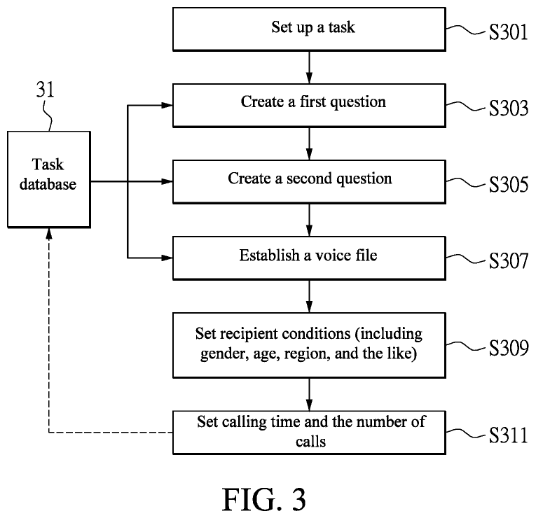

When the call center task is started, reference may be made to the process embodiment shown in FIG. 3 to begin the execution of the call center task (step S301). The call center task setup system acquires a task content from the task database 31 according to the task (step S303); obtains the calling time, number of calls, and recipient list from the task database 31, and makes phone calls to recipients with an automatic dialing function (step S305) to execute the questionnaire procedure. The phone interview may be executed by a call center agent; or the system can acquire a voice file from the task database 31 and automatically play back the voice file related to the questions (step S307).

Finally, the process is ended after the phone is hung up, and an interview result is generated (step S309). Relevant records are created (step S311), which are all stored in the task database 31 by means of the foregoing various setups. The interview result may be answers to the questions from by the recipients after the call is put through; or may indicate that the recipient has not answered all the questions, that is, the questionnaire procedure is interrupted, or no recipient is successfully contacted, or the phone number does not exist.

Subsequently, embodiments showing a call center task setup method are described with reference to several schematic diagrams of webpages. For example, FIG. 4 is a schematic diagram of an embodiment showing task setup using a user interface according to the method.

FIG. 4 shows a task setup page 40 for a customer to make initial setups, including setups in an account 401 column and a name 402 column for a call center task, a control 403 column for determining whether to automatically or manually dial for a telephone interview, a time 404 column for editing the start time and end time of the questionnaire procedure, and a quantity 405 column for setting the number of calls. The recipient information can be edited in a recipient 406 column. For example, according to the recipient conditions, recipient information can be acquired from a recipient database provided by the system.

In actual operation, if a common market research is to be conducted, the system randomly selects samples from the recipient database according to the recipient conditions for the call center to conduct the questionnaire procedure.

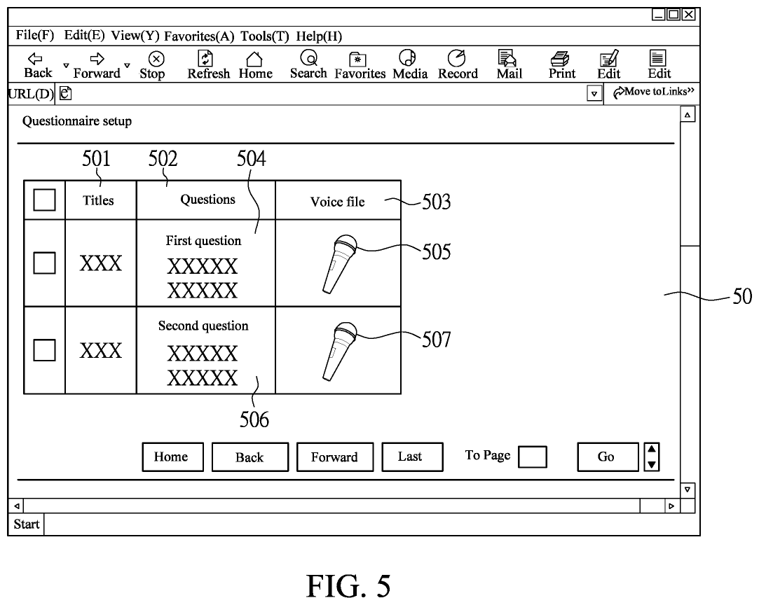

Subsequently, FIG. 5 is a schematic diagram of an embodiment showing questionnaire setup using a user interface. This embodiment shows a questionnaire setup page 50 for a customer to create one or more questions and set up a questionnaire procedure. When multiple questions are created via the questionnaire setup page 50, a sequence of these questions needs to be set, and a logical relationship therebetween needs to be determined. That is, when a specific answer is given, a subsequent question is provided or skipped.

In this embodiment, a titles 501 column and a questions 502 column are set up via the questionnaire setup page 50. A first question 504 and a second question 506 are shown herein. The second question 506 comes after the first question 504 when a given answer to the first question 504 meets a specific condition, and so forth. Then, a voice file 503 is set up, for example, the first question 504 can correspond to a first voice recording 505, and the second question 506 can correspond to a second voice recording 507.

In an embodiment, the call center task setup system may provide a combination of different types of machine speech. For example, numerals such as 1, 2, and 3 are recorded by machine, and English is processed in the same manner. Output of Chinese speech may also be provided, such that the customer can form a voice file by a combination of the machine speech.

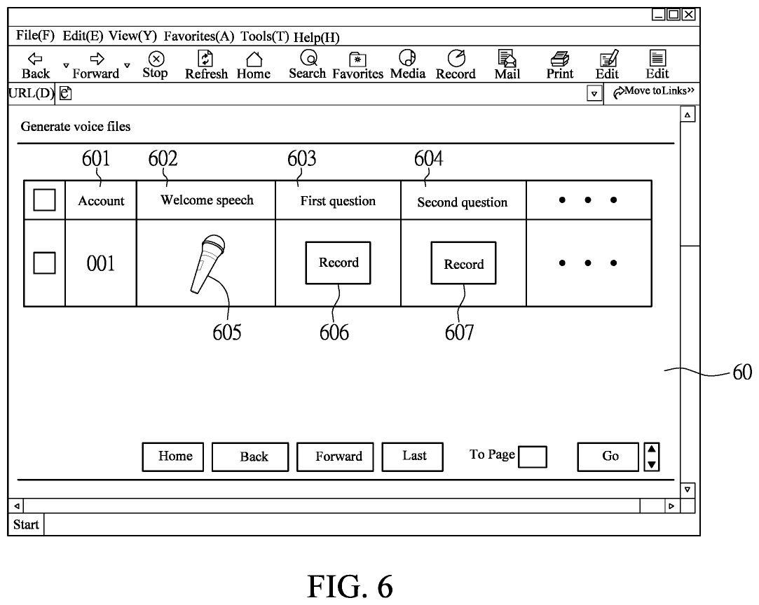

For a relevant embodiment, reference is made to FIG. 6 which is a schematic diagram showing voice recording setup using a user interface.

FIG. 6 shows a voice-recording setup page 60 for a customer to set up at least one voice file for each question. These voice files may be recorded by a user device connected to the call center task setup system, and then uploaded to the system via the voice-recording setup page 60.

On the voice-recording setup page 60 shown in the figure, an account 601 is set, and the customer can also set a welcome speech 602 or yes/no question before the start of the questionnaire. Voice recording for every question is subsequently performed. For example, a recording button 606 is provided below the first question 603 column. The customer can record voice online with a voice recording function on the page to generate a voice file, or upload a recorded voice file, or form a voice file by a combination of the machine speech provided by the system. Likewise, the second question 604 corresponds to a recording button 607 for voice recording. In FIG. 6, a specific pattern, such as a recording complete pattern 605, is used to indicate that the recording is completed. Alternatively, information indicating that the recording is not completed may be provided as a prompt.

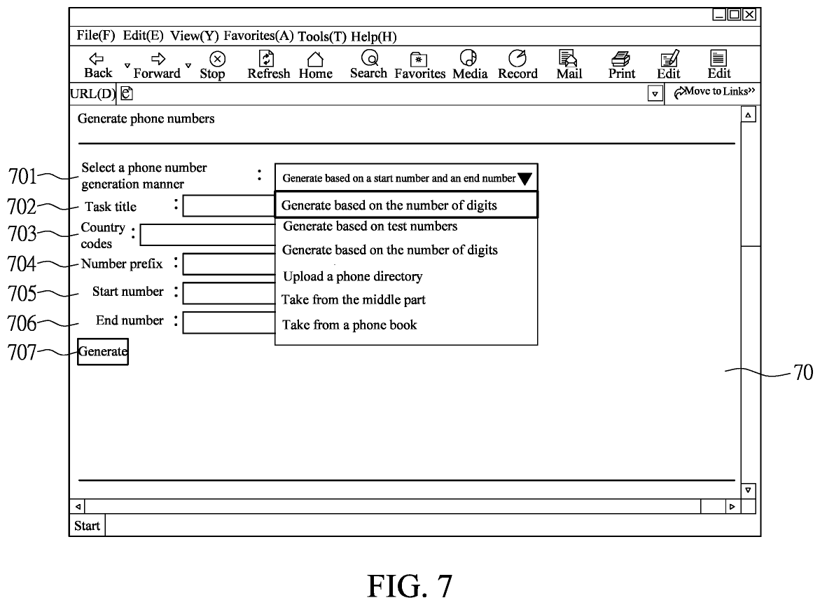

FIG. 7 is a schematic diagram of an embodiment showing setup of recipient phone numbers using a user interface. FIG. 7 provides a recipient phone number setup page 70 via which a recipient list can be set up according to the recipient conditions and a phone number generation manner can be accordingly selected.

In the column of “Select a phone number generation manner” 701, the customer can choose one from the phone number generation manners provided by the system. The options are listed as follows: “Generate based on a start number and an end number” in a sequence of phone numbers, “Generate based on the number of digits”, “Generate based on test numbers” created in increments of one, “Upload a phone directory” (for a customer to self-upload phone numbers of the recipients), “Draw from the middle”, and “Draw from a phone book”.

The recipient phone number setup page 70 is also provided with columns such as task title 702, country codes 703, number prefix 704, start number 705, and end number 706. A recipient list can be generated by using a generation button 707.

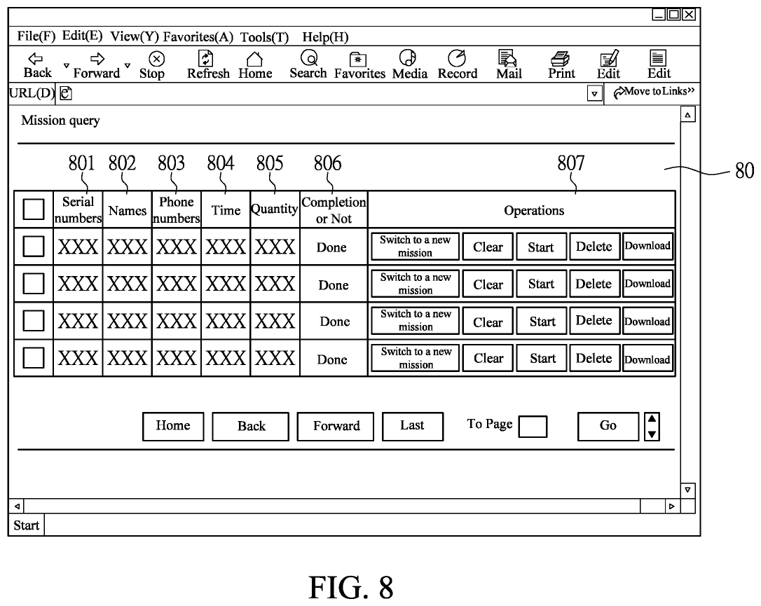

The customer can query for information in the system after task completion or during execution of a task, as shown in FIG. 8, which is a schematic diagram of an embodiment showing a task query using a user interface.

Columns for status inquiry are provided on a task query page 80, including serial numbers 801, names 802, phone numbers 803, time 804, quantity 805, and completed or incomplete 806. The corresponding statuses can be checked via these columns. In addition, several functional buttons are provided below the column of operations 807. For example, for the button “Switch to a new task”, during status inquiry of one or more recipients, if it is found that some of them have become potential customers or recipients with a specific purpose, it can be evaluated whether to perform a switch to a new task.

Below the operation 807 column, the following functional buttons are additionally provided: The button “Clear” indicates a function of clearing a current query action, the button “Start” indicates a function of re-dialing the phone number of a specific recipient, the button “Delete” indicates a function of deleting a record of a particular recipient, and the button “Download” indicates a function of downloading selected data.

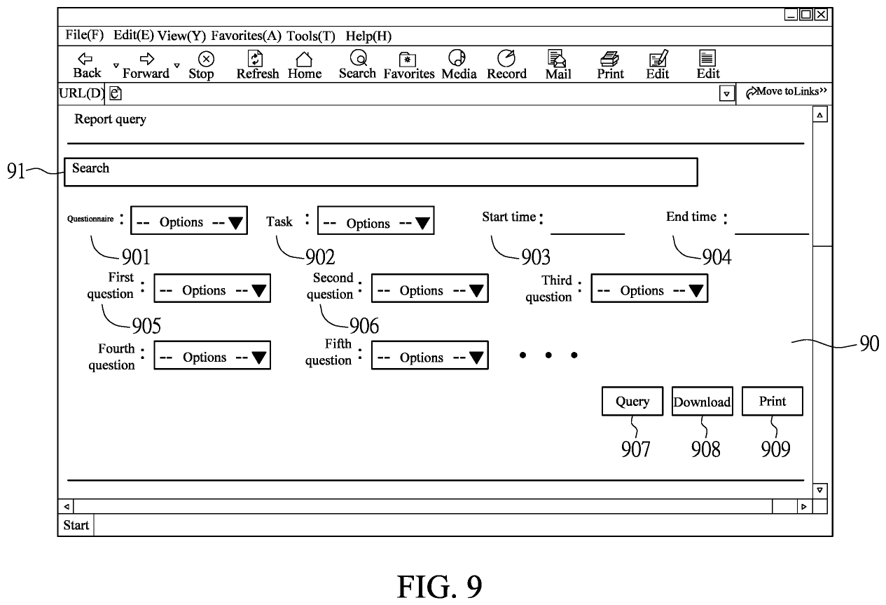

FIG. 9 is a schematic diagram of an embodiment showing a report query using a user interface.

FIG. 9 shows a report query page 90 for querying for an interview result with respect to the call center task. A search function 91 can be used to query for not only a result of the whole questionnaire but also an interview result of a specific question. Other columns for query include a questionnaire 901 column, a task 902 column, a start time 903 column, and an end time 904 column. Furthermore, a function of querying for specific questions such as a first question 905 and a second question 906 is also set up. A query button 907 is used for querying, a download button 908 is used by the customer to download a query result, and a print button 909 is used for printing out a report.

After the customer completes the setup of the questionnaire and recipient range according to the call center task, the system starts a survey procedure at the set start time, and ends the procedure at the end time. When the procedure is started, the system automatically dials phone numbers according to settings of the recipients, and conducts a survey using pre-recorded voice.

For example, for the first question: “Where is your place of domicile?”, options may be provided according to set parameters as follows: (1) Taipei City, (2) Taichung City, (3) Tainan City, and (4) Kaohsiung City. After a recipient makes a selection from the options (or the recipient may express his/her unwillingness to be interviewed, which would end the process), the process goes to the second question: “What is your age and gender?”, and options may be provided as follows: (1) Female aged 20 to 40, (2) Male aged 20 to 40, (3) Female over 40 years old, and (4) Male over 40 years old.

Then, the process goes to the third question: “Where do you buy coffee?”, and options may be provided as follows: (1) Shoujia Coffee, (2) Wenzhe Coffee, (3) Huanxin Coffee, (4) Tin Coffee, (5) Wenzhi Coffee, and (6) None of the above. In the following fourth question, the recipient may be asked if he/she is willing to accept another interview. After an answer to this question is recorded by the system, setup of a recipient list in the future may be performed based on the answer.

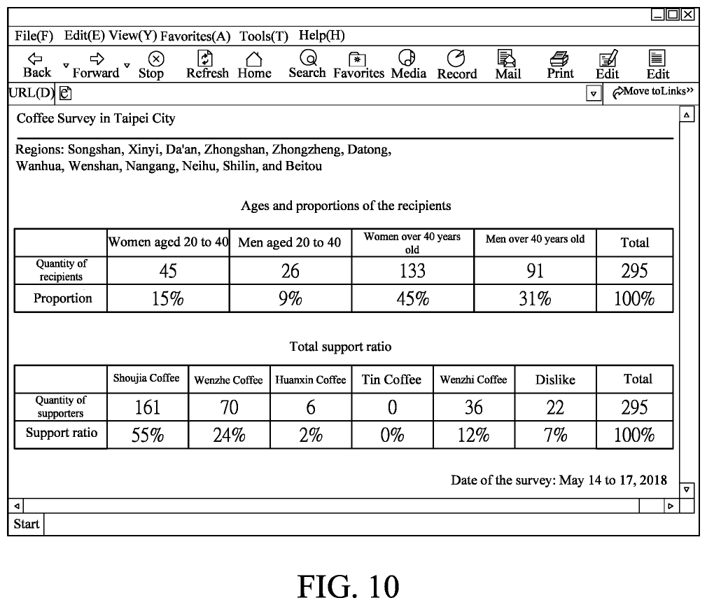

FIG. 10 shows an implementation instance in which a customer produces a report by using the call center task setup system, where the report can clearly show a questionnaire result.

In the form of a report, this embodiment shows a questionnaire result of “Coffee Survey in Taipei City” on May 14 to 17, 2018. The collected statistics cover regions including Songshan, Xinyi, Da'an, Zhongshan, Zhongzheng, Datong, Wanhua, Wenshan, Nangang, Neihu, Shilin, and Beitou. The report also shows results of different items obtained after collection of statistics. For the “Ages and proportions of the recipients”, there are 45 women aged 20 to 40, accounting for 15% of the total 295 recipients; there are 26 men aged 20 to 40, accounting for 9% of the total recipients; there are 133 women over 40 years old, accounting for 45%; and there are 91 men over 40 years old, accounting for 31%.

The questionnaire result also shows a “Total support ratio”. In the instance, 161 of the total 295 recipients support Shoujia Coffee, accounting for 55% of the total; 70 recipients support Wenzhe Coffee, accounting for 24%; 6 recipients support Huanxin Coffee, accounting for 2%; no recipient supports Tin Coffee, accounting for 0%; 36 recipients support Wenzhi Coffee, accounting for 12%; and 22 recipients express that they like none of them, accounting for 7% of the total.

It should be noted that, aside from the presented form of the report shown in FIG. 10, various charts may also be used, such as a pie chart, a bar chart, a curve chart, and the like.

To sum up, according to the foregoing embodiments of the call center task setup system and method, a customer can remotely set up a call center task via webpages (which may refer to various software interfaces) by using the call center task setup system. By an automated program, the system can set up questions, voice content and a process of a questionnaire procedure to be executed by the call center, so as to rapidly and conveniently design a questionnaire procedure and use the call center to execute the questionnaire procedure.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A call center task setup system, comprising:
a server system having a database, executing a web server, and providing a call center task setup function, wherein:
a task setup page is provided to set up a call center task, including an automatic dialing function, calling time, the number of calls, and recipient conditions;
a questionnaire setup page is provided to create one or more questions and set up a questionnaire procedure;
a voice-recording setup page is provided to set up at least one voice file for each question; and
a recipient phone number setup page is provided to set up a recipient list according to the recipient conditions and select a phone number generation manner via this page; and
when the call center task is started, the call center task setup system makes phone calls to recipients with the automatic dialing function based on the calling time, the number of calls, and the recipient list, and executes the questionnaire procedure.

2. The call center task setup system of claim 1, wherein when multiple questions are created via the questionnaire setup page, a sequence of the multiple questions is set, and a logical relationship between the multiple questions is determined.

3. The call center task setup system of claim 1, wherein after setup completion of the call center task, a cost is automatically calculated.

4. The call center task setup system of claim 1, wherein a task query page is further provided to query for statuses of the recipients, and estimate whether to perform a switch to a new task.

5. The call center task setup system of claim 1, wherein a report query page is also provided to query for an interview result with respect to the call center task.

6. The call center task setup system of claim 4, wherein interview results of multiple questions with respect to the call center task can also be queried for.

7. The call center task setup system of claim 6, wherein when the multiple questions are created via the questionnaire setup page, a sequence of the multiple questions is set, and a logical relationship between the multiple questions is determined.

8. The call center task setup system of claim 1, wherein the voice file is recorded with a user device connected to the call center task setup system, and is then uploaded to the call center task setup system via the voice-recording setup page.

9. The call center task setup system of claim 8, wherein when multiple questions are created via the questionnaire setup page, a sequence of the multiple questions is set, and a logical relationship between the multiple questions is determined.

10. A call center task setup method, wherein a web server is executed in a server system to enable a user device to set up a call center task using multiple webpages via the network, and the method comprises:
providing a task setup page to set up the call center task, including an automatic dialing function, calling time, the number of calls, and recipient conditions;
providing a questionnaire setup page to create one or more questions and set up a questionnaire procedure;
providing a voice-recording setup page to set up at least one voice file for each question; and
providing a recipient phone number setup page to set up a recipient list according to the recipient conditions and select a phone number generation manner via this page; and
when the call center task is started, a call center task setup system makes phone calls to recipients with the automatic dialing function based on the calling time, the number of calls, and the recipient list, and executes the questionnaire procedure.

11. The call center task setup method of claim 10, wherein when multiple questions are created via the questionnaire setup page, a sequence of the multiple questions is set, and a logical relationship between the multiple questions is determined.

12. The call center task setup method of claim 10, wherein the voice file is recorded with user device connected to the call center task setup system, and is then uploaded to the call center task setup system via the voice-recording setup page.

13. The call center task setup method of claim 12, wherein when multiple questions are created via the questionnaire setup page, a sequence of the multiple questions is set, and a logical relationship between the multiple questions is determined.
